(19) United States
(12) Patent Application Publication
(10) Pub. No.: US 2017/0054906 A1
(43) Pub. Date: Feb. 23, 2017

(54) METHOD AND DEVICE FOR GENERATING A PANORAMA

(71) Applicant: Xiaomi Inc., Beijing (CN)

(72) Inventors: Tao CHEN, Beijing (CN); Mingyong Tang, Beijing (CN); Huayijun Liu, Beijing (CN)

(73) Assignee: Xiaomi Inc.

(21) Appl. No.: 15/181,683

(22) Filed: Jun. 14, 2016

(30) Foreign Application Priority Data
Aug. 21, 2015 (CN) 201510518423.7

(51) Int. Cl. H04N 5/232; G06T 7/20

(52) U.S. Cl. CPC H04N 5/23238; G06T 7/20

(57) ABSTRACT

A method for generating a panorama is disclosed. The method may include obtaining status information of a camera device during a video capture, determining whether the status information meets a preset condition, if the status information is determined to meet the preset condition, obtaining, from a video file generated from the video capture, a video dip corresponding to the status information, and generating a panorama based on the video clip.

### CROSS-REFERENCE TO RELATED APPLICATIONS

This application is based upon and claims priority to Chinese Patent Application 201510518423.7 filed on Aug. 21, 2015, the entire content of which is incorporated herein by reference.

### TECHNICAL FIELD

The present disclosure generally relates to the field of photography and, more particularly, to a method and a device for generating a panorama.

### BACKGROUND

With technology advance in photography, panorama capturing using a camera has been widely used. By moving a camera lens freely, more scenes may be captured in one photo. With current technologies, a camera may not record a video while shooting a panorama, and also may not shoot a panorama while recording a video. That is, video recording and panorama capturing cannot be performed simultaneously. As a consequence, a user may miss capturing desirable scenes for a panorama or video.

### SUMMARY

One aspect of the present disclosure is directed to a method for generating a panorama. The method may comprise obtaining status information of a camera device during a video capture, determining whether the status information meets a preset condition, if the status information is determined to meet the preset condition, obtaining, from a video file generated from the video capture, a video clip corresponding to the status information, and generating a panorama based on the video clip.

Another aspect of the present disclosure is directed to a device for generating a panorama. The device may comprise a processor and a memory configured to store an instruction executable by the processor. The processor may be configured to obtain status information of a camera device during a video capture, determine whether the status information meets a preset condition, if the status information is determined to meet the preset condition, obtain, from a video file generated from the video capture, a video clip corresponding to the status information, and generate a panorama based on the video clip.

Another aspect of the present disclosure is directed to a non-transitory computer-readable storage medium storing instructions that, when executed by a processor, cause the processor to perform a method for generating a panorama. The method may comprise obtaining status information of a camera device during a video capture, determining whether the status information meets a preset condition, if the status information is determined to meet the preset condition, obtaining, from a video file generated from the video capture, a video clip corresponding to the status information; and generating a panorama based on the video clip.

It is to be understood that the foregoing general description and the following detailed description are exemplary and explanatory only, and are not restrictive of the invention, as claimed.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1A is a flow chart illustrating a method for generating a panorama, according to an exemplary embodiment.

FIG. 1B is a diagram illustrating a method for generating a panorama, according to an exemplary embodiment.

FIG. 2 is a flow chart illustrating a method for generating a panorama, according to an exemplary embodiment.

FIG. 3 is a flow chart illustrating a method for generating a panorama, according to an exemplary embodiment.

FIG. 4 is a block diagram illustrating a device for generating a panorama, according to an exemplary embodiment.

FIG. 5 is a block diagram illustrating another device for generating a panorama, according to an exemplary embodiment.

FIG. 6 is a block diagram illustrating another device for generating a panorama, according to an exemplary embodiment.

### DETAILED DESCRIPTION

Reference will now be made in detail to exemplary embodiments, examples of which are illustrated in the accompanying drawings. In the description below, unless indicated otherwise, identical references in different drawings represent identical or like elements. Implementations in the following exemplary embodiments do not represent all implementations according to the disclosure. On the contrary, they are merely examples of devices and methods according to some aspects of the disclosure as recited in the appended claims.

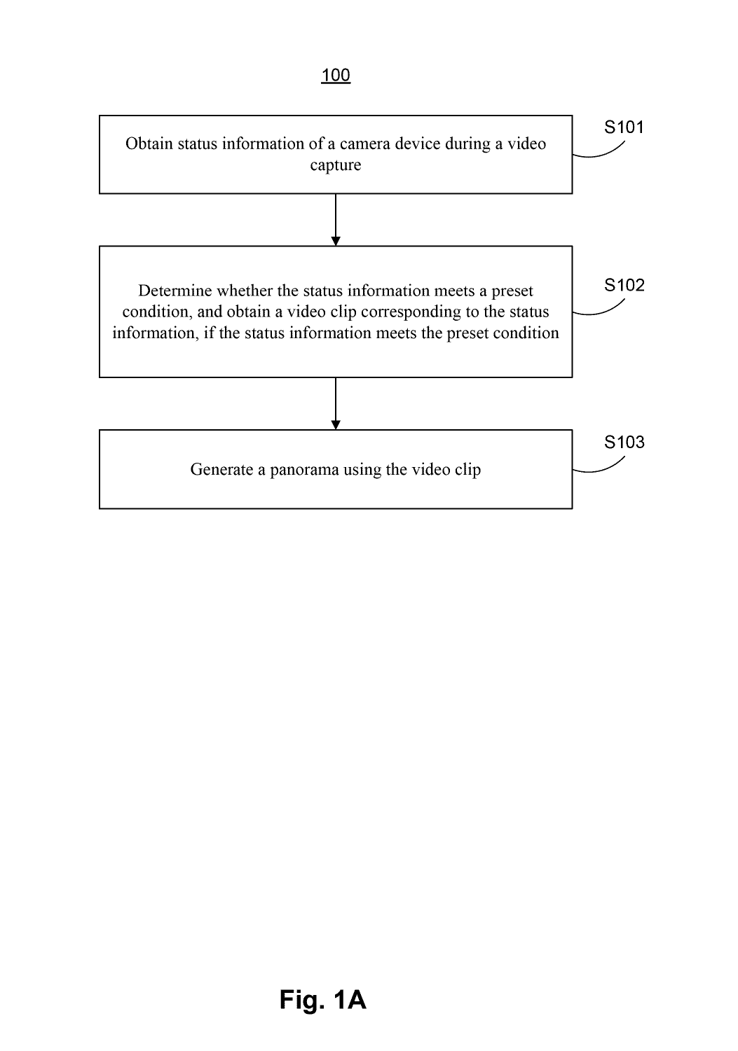

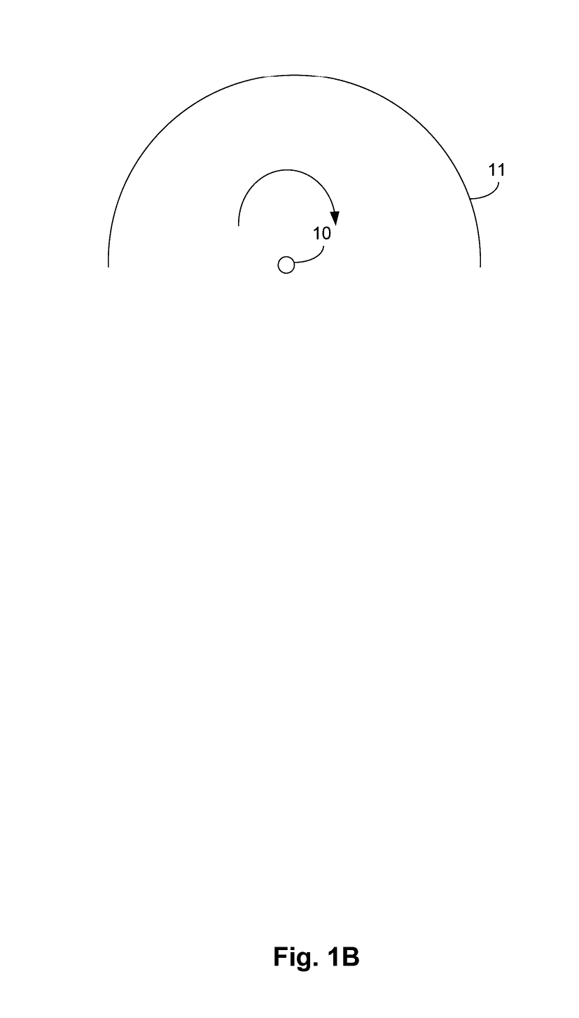

FIG. 1A is a flow chart illustrating a method 100 for generating a panorama, according to an exemplary embodiment. The method 100 may be implemented by a terminal device, such as a video camera, a camera, a smart phone, a tablet computer having a camera, a desktop computer capable of playing a video file, etc. The terminal device may include a camera device. The terminal device may include a processor and a non-transitory computer-readable storage medium storing instructions that, when executed by the processor, cause the terminal device to perform the method 100. The non-transitory computer-readable storage medium may embody an application (app) or software on the terminal device. Referring to FIG. 1A, the method 100 may include steps 101 through 103 as follows.

In step 101, status information of a camera device during a video capture is obtained.

In one embodiment, the video capture may generate a video file and the status information of the camera device during the video capture may be stored in a video file in a preset format, or may be stored in a configuration file corresponding to the video file. The configuration file may be configured to record the status information. The status information may include a horizontal movement speed and a horizontal movement angle of the camera device.

In step 102, it is determined whether the status information meets a preset condition, and a video clip corresponding to the status information is obtained from the video file generated from the video capture, if the status information meets the preset condition.

In one embodiment, whether the status information meets the preset condition may be determined by the speed of the horizontal movement and the angle of the horizontal movement of the camera device during the video capture. For example, when the speed of the horizontal movement of the camera device is smaller than a first preset threshold and the angle of the horizontal movement is larger than a second preset threshold, it may be determined that the video clip meets the set condition. The video clip may be obtained or extracted from the corresponding video file.

In step 103, a panorama is generated using the video clip.

FIG. 19 is a diagram illustrating generating a panorama using the methods in the present disclosure, according to an exemplary embodiment. In FIG. 19, reference numeral 11 illustrates a combined field of view of a Charge-coupled Device (CCD) of a camera device 10, when the camera device 10 moves along a direction represented by an arrow during a continuous capture. During the capture, a speed of a horizontal movement and an angle of the horizontal movement of the camera device 10 may he acquired using a gyroscope in the camera device 10. When the speed of the horizontal movement of the camera device 10 is smaller than a first preset threshold, it may indicate that a panorama corresponding to a recorded video clip has a high definition. When the angle of the horizontal movement of the camera device 10 is larger than a second preset threshold, it may indicate that the panorama corresponding to the video clip has a large field of view.

In one embodiment, a video clip corresponding to status information that meets a preset condition can be obtained or extracted from a video file, and a panorama can be generated using the video clip. With the panorama generated using a video footage from the video file, it is not necessary to additionally capture a panorama in a panorama mode, thus improving the user experience.

In one embodiment, the status information may include a speed of a horizontal movement and an angle of the horizontal movement. The status information of the camera device during a video capture may be determined as follows.

The speed of the horizontal movement of the camera device may he determined using a gyroscope.

The angle of the horizontal movement of the camera device may be determined using the gyroscope.

In one embodiment, determining whether the status information meets the preset condition may include: determining whether the speed of the horizontal movement is smaller than a first preset threshold, and determining whether the angle of the horizontal movement is larger than a second preset threshold.

When the speed of the horizontal movement is determined to be smaller than the first preset threshold, and the angle of the horizontal movement is determined to be larger than the second preset threshold, the status information may be determined to meet the preset condition.

In one embodiment, the method 100 may further include: when the speed of the horizontal movement is larger than the first preset threshold, and/or the angle of the horizontal movement is smaller than the second preset threshold, notifying a user that no video clip can be determined from the video file to generate the panorama.

In one embodiment, the video clip corresponding to the status information may be obtained or extracted as follows.

A starting time of a horizontal movement and an ending time of the horizontal movement may be obtained. The video clip may be obtained according to the starting time and the ending time.

In one embodiment, the status information may include a speed of a horizontal movement and an angle of the horizontal movement. The status information of the camera device may be determined as follows.

The speed of the horizontal movement and the angle of the horizontal movement of the camera device may be determined from a configuration file corresponding to the video file.

In one embodiment, the panorama can be generated using the video footage from the video file, thus improving the user experience.

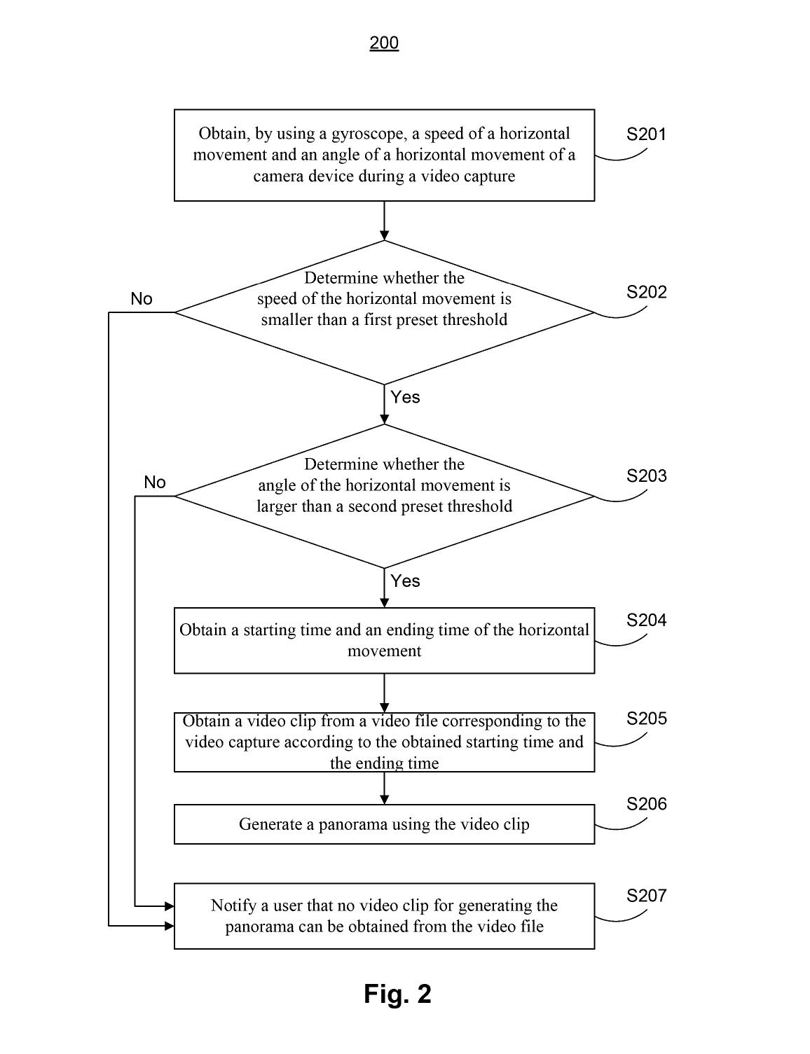

FIG. 2 is a flow chart illustrating a method 200 for generating a panorama, according to an exemplary embodiment. The method 200 may be implemented where a camera device generates a panorama during a video capture. The method 200 may be implemented by the terminal device described above. Referring to FIG. 2, the method 200 may include the following steps.

In step 201, by using a gyroscope, a speed of a horizontal movement and an angle of a horizontal movement of a camera device during a video capture is obtained.

In step 202, it is determined whether the speed of the horizontal movement is smaller than a first preset threshold. If the speed of the horizontal movement is determined to be smaller than the first preset threshold, step 203 may be performed. If the speed of the horizontal movement is determined to be larger than or equal to the first preset threshold, step 207 may be performed.

In step 203, it is further determined whether the angle of the horizontal movement is larger than a second preset threshold. If the angle of the horizontal movement is determined to be larger than the second preset threshold, step 204 may be performed, if the angle of the horizontal movement is determined to be smaller than or equal to the second preset threshold, step 207 may be performed.

In one embodiment, the first preset threshold and the second preset threshold may be empirical values of the speed of the horizontal movement and the angle of the horizontal movement of the camera device. The empirical values may correspond to a desirable image quality of the panorama.

In step 204, a starting time and an ending time of the horizontal movement are obtained.

In step 205, a video clip from a video file corresponding to the video capture is obtained according to the obtained starting time and the ending time.

In one embodiment, the camera device may record the starting time and the ending time of the horizontal movement of the camera device. The starting time and the ending time may be recorded in the video file in a preset format.

In step 206, a panorama is generated using the video clip.

In step 207, a notice is provided to a user notifying that no video clip for generating the panorama can be determined from the video file.

In some embodiments, as shown in FIG. 1B, a film screw may capture a video of a scene for a film with the camera device 10, and a lens of the camera device 10 may move horizontally and slowly with the camera device 10. In addition, an art department may control the surrounding light and the environment during the entire scene capture to achieve uniform illumination to the camera device 10, such that a video clip with desirable quality can be obtained or extracted from the captured video of the scene and a panorama can be generated from the captured video clip to use as a poster of the film.

For example, during the filming, the camera device 10 may acquire, using a gyroscope, a speed of the horizontal movement and an angle of the horizontal movement of the camera device 10. If it is determined that the speed of the horizontal movement of the camera device 10 is smaller than a first preset threshold and the angle of the horizontal movement of the camera device 10 is larger than a second preset threshold, a video clip corresponding to the horizontal movement may be marked from the video capture, such that a panorama may be generated using the video clip according to the mark.

In the illustrated embodiment, if a camera device determines that that a speed of a horizontal movement is smaller than a first threshold and an angle of the horizontal movement is larger than a second preset threshold during a video capture, the camera device may generate a panorama using a video clip corresponding to the horizontal movement. Thus, while a video is being captured, a panorama may be generated from a video clip with a desirable quality, achieving video and panorama capturing at the same time.

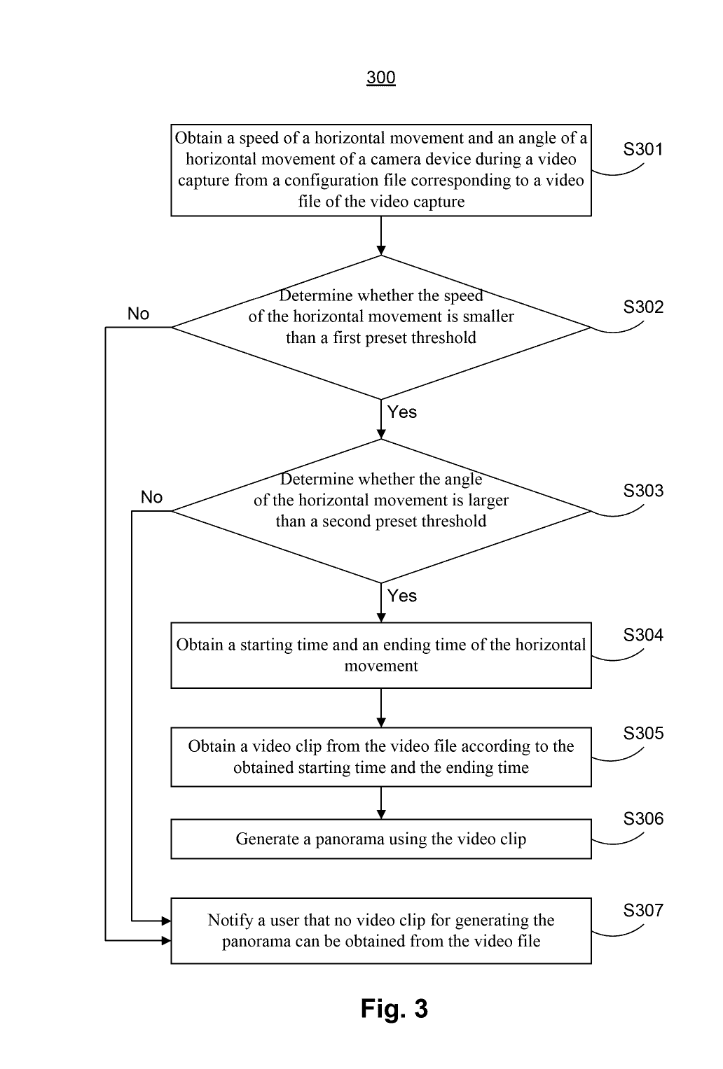

FIG. 3 is a flow chart illustrating a method 300 for generating a panorama, according to an exemplary embodiment. The method 300 may include capturing a video file with a camera device, and generating a panorama on a terminal device using the video file. The method 300 may be implemented by the terminal device described above. Referring to FIG. 3, the method 300 may include the following steps.

In step 301, a speed of a horizontal movement and an angle of a horizontal movement of a camera device during a video capture are obtained from a configuration file corresponding to a video file of the video capture.

In step 302, it is determined whether the speed of the horizontal movement is smaller than a first preset threshold. If the speed of the horizontal movement is determined to be smaller than the first preset threshold, step 303 may be performed. If the speed of the horizontal movement is determined to be larger than or equal to the first preset threshold, step 307 may be performed.

In step 303, it is further determined whether the angle of the horizontal movement is larger than a second preset threshold. If the angle of the horizontal movement is determined to be larger than the second preset threshold, step 304 may be performed, if the angle of the horizontal movement is determined to be smaller than or equal to the second preset threshold, step 307 may be performed.

In step 304, a starting time and an ending time of the horizontal movement are obtained.

In step 305, a video clip from the video file is obtained according to the obtained starting time and the ending time.

In step 306, a panorama is generated using the video clip.

In step 307, a notice is provided to a user notifying that no video clip for generating the panorama can be obtained from the video file.

In some embodiments, the terminal device may read, from a configuration file corresponding to a video file of a video capture, a speed of a horizontal movement and an angle of the horizontal movement of the camera device. If the speed of the horizontal movement of camera device is determined to be smaller than a first preset threshold and the angle of the horizontal movement of camera device is determined to be larger than a second preset threshold, a starting time and an ending time of the horizontal movement may be obtained, and a panorama can be generated using a video clip corresponding to the starting time and the ending time.

For example, a duration of a film scene captured by the camera device 10 (FIG. 1B) is 60 minutes, and the terminal device determines that, from the 45th minute through the 50th minute of the captured film scene, a speed of a horizontal movement of the camera device 10 is smaller than the first preset threshold, and an angle of the horizontal movement is lamer than the second preset threshold. In this case, a panorama may be generated using a video clip corresponding to the captured film from the 45th minute to the 50th minute.

In one embodiment, the terminal device may acquire, from a configuration file corresponding to a video file, a speed of a horizontal movement and an angle of the horizontal movement of a camera device during a video capture. If it is determined that the speed of the horizontal movement is smaller than a first preset threshold and the angle of the horizontal movement is larger than a second preset threshold, the terminal device may generate a panorama using a video clip corresponding to the horizontal movement. Thus, a panorama may be generated from a video clip with desirable quality, achieving video and panorama capturing at the same time.

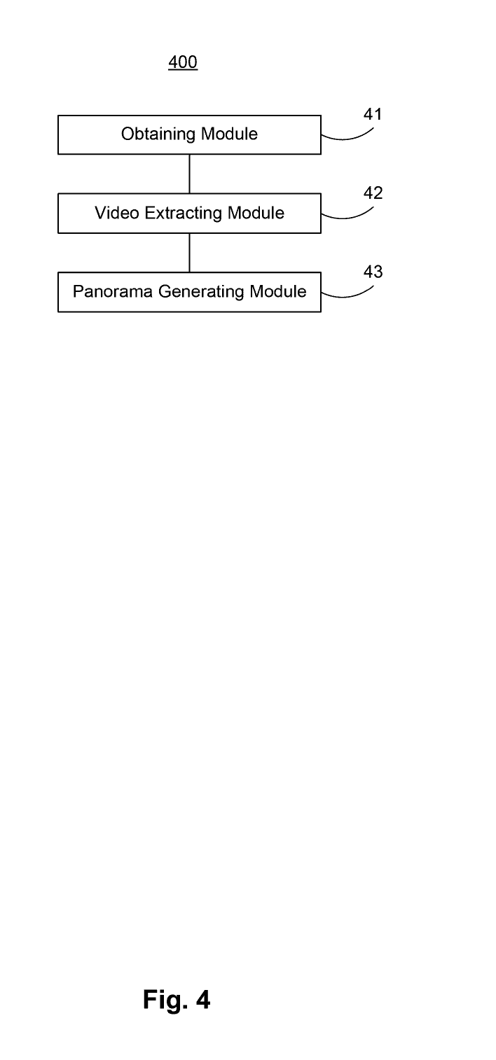

FIG. 4 is a block diagram illustrating a device 400 for generating a panorama, according to an exemplary embodiment. The device 400 may be the terminal device described above. Referring to FIG. 4, the device 400 may include: a obtaining module 41 configured to obtain status information of a camera device during a video capture; a video extracting module 42. configured to determine whether the status information determined by the determining module 41 meets a preset condition, and obtain a video clip from a video file corresponding to the video capture based on the status information, if the status information meets the preset condition; and a panorama generating module 43 configured to generate a panorama using the video clip determined by the video extracting module 42.

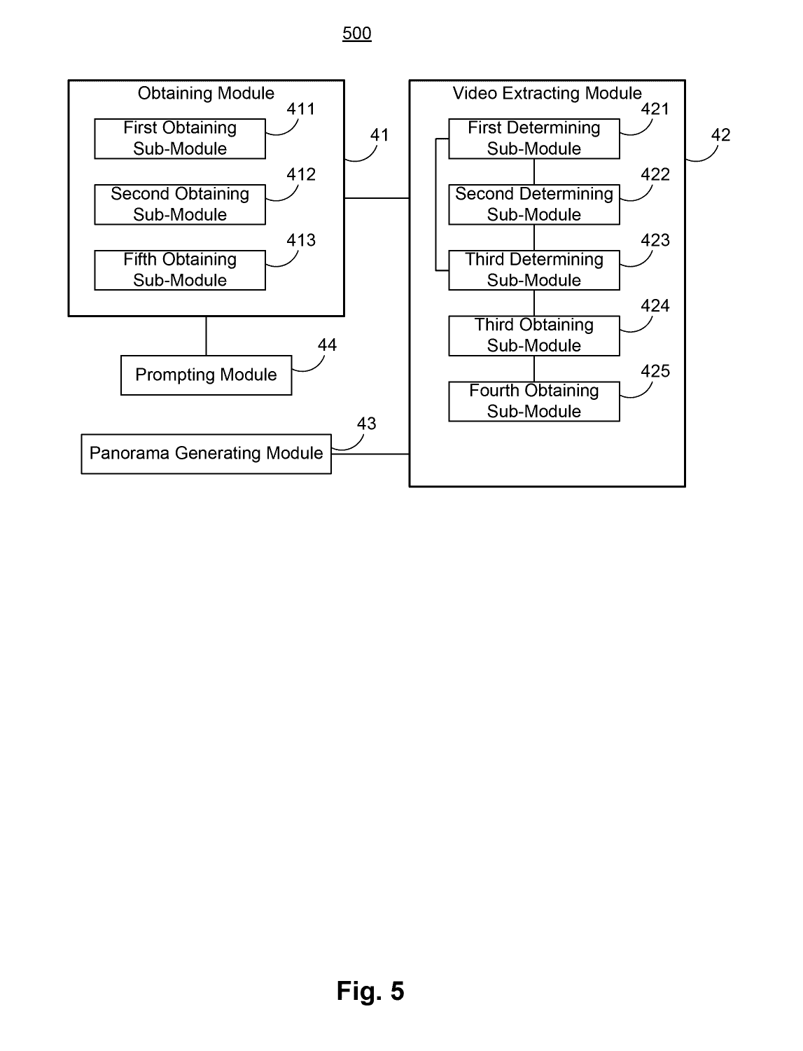

FIG. 5 is a block diagram illustrating a device 500 for generating a panorama, according to an exemplary embodiment. In the embodiment status information includes a speed of a horizontal movement and an angle of the horizontal movement. Referring to FIG. 5, the device 500 includes a prompting module 44, in addition to the obtaining module 41, the video extracting module 42, and the panorama generating module 43 (FIG. 4).

In one embodiment, the obtaining module 41 may include: a first obtaining sub-module 411 configured to obtain, using a gyroscope, the speed of the horizontal movement of the camera device during the video capture; and a second obtaining sub-module 412 configured to obtain, using a gyroscope, the angle of the horizontal movement of the camera device during the video capture.

In one embodiment, the video extracting module 42 may include: a first determining sub-module 421 configured to determine whether the speed of the horizontal movement obtained by the first obtaining sub-module 411 is smaller than a first preset threshold; a second determining sub-module 422 configured to determine whether the angle of the horizontal movement obtained by the second obtaining sub-module 412 is larger than a second preset threshold; and a third determining sub-module 423 configured to, if the first determining sub-module 421 determines that the speed of the horizontal movement is smaller than the first preset threshold and the second determining sub-module 422 determines that the angle of the horizontal movement is larger than the second preset threshold, determine that the status information meets the preset condition.

In one embodiment, the device 500 may further include the prompting module 44 configured to, when the speed of the horizontal movement obtained by the first obtaining sub-module 411 is larger than the first preset threshold, and/or the angle of the horizontal movement obtained by the second obtaining sub-module 412 is smaller than the second preset threshold, provide a notice to a user notifying that no video clip for generating the panorama can be determined from the video file.

In one embodiment, the video extracting module 42 may include: a third obtaining sub-module 424 configured to obtain a starting time and an ending time of the horizontal movement after the third determining sub-module 423 determines that the preset condition is met; and a fourth obtaining sub-module 425 configured to obtain the video clip according to the starting time and the ending time determined by the third obtaining sub-module 424.

In one embodiment, the determining module 41 may include a fifth obtaining sub-module 413 configured to obtain, from a configuration file corresponding to the video file, the speed of the horizontal movement and the angle of the horizontal movement of the camera device during a video capture.

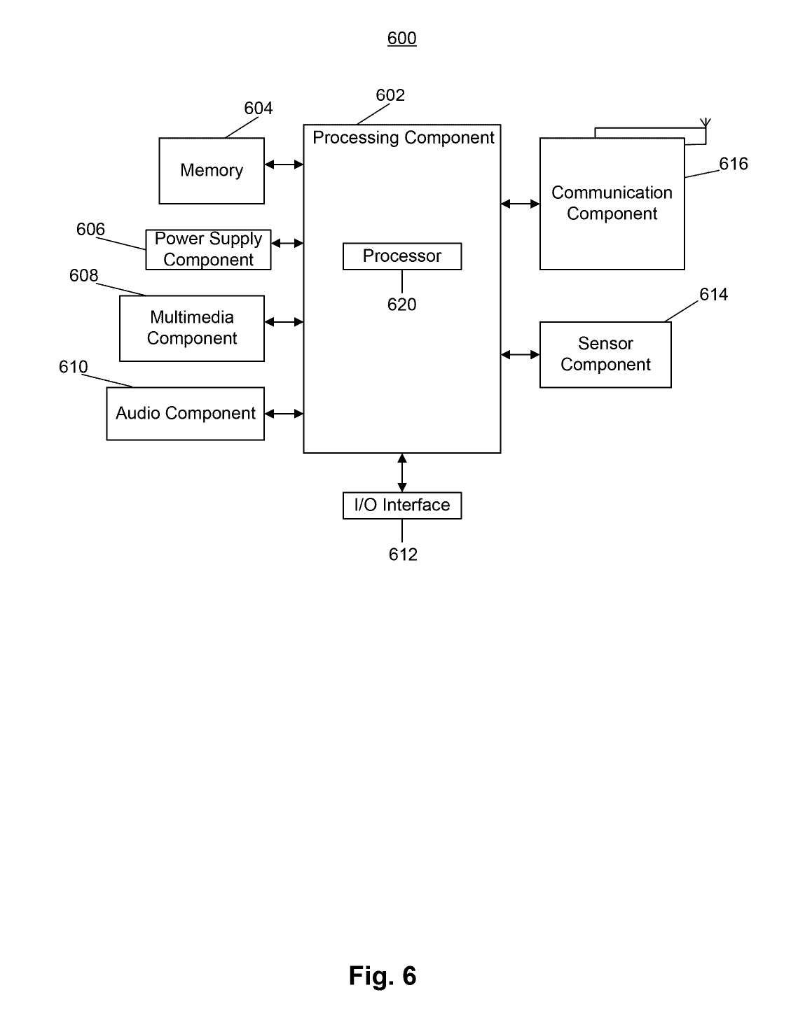

FIG. 6 is a block diagram illustrating a device 600 for generating a panorama, according to an exemplary embodiment. For example, the device 600 may be a terminal device, such as a mobile phone, a computer, a digital broadcasting terminal, a message transceiver, a game console, a tablet device, a medical device, a fitness device, a personal digital assistant, and/or the like.

Referring to FIG. 6, the device 600 may include one or more of the following components: a processing component 602, a memory 604, a power supply component 606, a multimedia component 608, an audio component 610, an Input/Output (I/O) interface 612, a sensor component 614, and a communication component 616.

The processing component 602 may control an overall operation of the device 600, such as operations associated with display, a telephone call, data communication, a camera operation, and a recording operation. The processing component 602 may include one or more processors 620 to execute instructions to implement all or some steps of the method described above. In addition, the processing component 602 may include one or more modules to facilitate interaction between the processing component 602 and other components. For example, the processing component 602 may include a multimedia module to facilitate interaction between the multimedia component 608 and the processing component 6020

The memory 604 may be configured to store various types of data to support the operation on the device 600. Example of such data may include instructions to implement any application or method on the device 600, contact data, phonebook data, messages, pictures, videos, and the like. The memory 604 may be realized by any type of volatile, non-transitory storage device, or any combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, magnetic disk, or compact disk.

The power supply component 606 may supply electric power to various components of the device 600. The power supply component 606 may include a power management system, one or more power sources, and other components related to generating, managing and distributing electricity for the device 600.

The multimedia component 608 may include a screen providing an output interface between the device 600 and a user. In some embodiments, the screen may include a Liquid Crystal Display (LCD) and a Touch Panel (DI). If the screen includes a TP, the screen may be realized as a touch screen to receive an input signal from a user. The TP may include one or more touch sensors for sensing touch, slide and gestures on the TP. The touch sensors may sense the boundary of a touch or slide move, and detect the duration and pressure related to the touch or slide move. In some embodiments, the multimedia component 608 may include a front camera and/or a rear camera. When the device 600 is in an operation mode such as a camera or video capture mode, the front camera and/or the rear camera may receive external multimedia data. Each of the front camera and the rear camera may include a fixed optical lens system or may have an adjustable focal length and be capable of optical zooming.

The audio component 610 may be configured to output and/or input an audio signal. For example, the audio component 610 may include a microphone (MIC). When the device 600 is in an operation mode such as a call mode, a recording mode, and a voice recognition mode, the MIC may be configured to receive an external audio signal. The received audio signal may be further stored in the memory 604 or may be sent via the communication component 616. In some embodiments, the audio component 610 may further include a loudspeaker configured to output the audio signal.

The I/O interface 612 may provide an interface between the processing component 602 and a peripheral interface module. The peripheral interface module may be a keypad, a click wheel, a button, or the like. The button may include a homepage button, a volume button, a start button, or a lock button.

The sensor component 614 may include one or more sensors for assessing various states of the device 600. For example, the sensor component 614 may detect an on/off state of the device 600 and relative positioning of components such as the display and the keypad of the device 600. The sensor component 614 may further detect a change in the position of the device 600 or of a component of the device 600, whether there is contact between the device 600 and a user, an orientation or acceleration/deceleration of the device 600, and a change in a temperature of the device 600. The sensor component 614 may include a proximity sensor configured to detect existence of a nearby object without physical contact. The sensor component 614 may further include an optical sensor such as a Complementary Metal-Oxide-Semiconductor (CMOS) or Charge-Coupled-Device (CCD) image sensor used in an imaging application. In some embodiments, the sensor component 614 may further include an acceleration sensor, a gyroscope sensor, a magnetic sensor, a pressure sensor, or a temperature sensor.

The communication component 616 may be configured to facilitate wired or wireless communication between the device 600 and other devices. The device 600 may access a wireless network based on a communication standard such as WiFi, 2G or 3G, or combination thereof. In an exemplary embodiment, the communication component 616 may receive a broadcast signal or broadcast related information from an external broadcast management system via a broadcast channel. In an exemplary embodiment, the communication component 616 may further include a Near Field Communication (NFC) module for short-range communication. For example, the NFC module may be based on Radio Frequency Identification (RFID), Infrared Data Association (IrDA), Ultra-Wideband (UWB) technology, Bluetooth (BT), and other technologies.

In an exemplary embodiment, the device 600 may be realized by one or more of Application Specific Integrated Circuits (ASIC), Digital Signal Processors (DSP), Digital Signal Processing Device (DSPD), Programmable Logic Devices (PLD), Field Programmable Gate Arrays (FPGA), controllers, microcontrollers, microprocessors or other electronic components to implement the method.

In an exemplary embodiment, there is provided a non-transitory computer-readable storage medium including instructions, such as included in the memory 604, executable by the processor 620 of the device 600, to implement the above described methods. For example, the non-transitory computer-readable storage medium may be a Read-Only Memory (ROM), a Compact Disc Read-Only Memory (CD-ROM), a magnetic tape, a floppy disk, an optical data storage device, etc.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments herein will be apparent to those skilled in the art from consideration of the specification and practice of the present disclosure. This application is intended to cover any variations, uses, or adaptations of the disclosure following the general principles thereof and including such departures from the present disclosure as come within known or customary practice in the art. The specification and the embodiments are intended to be exemplary only, with a true scope and spirit of the disclosure being indicated by the appended claims.

It will be appreciated that the present disclosure is not limited to the exact construction that has been described above and illustrated in the accompanying drawings, and that various modifications and changes can be made without departing from the scope thereof it is intended that the scope of the present disclosure be limited only by the appended claims.

What is claimed is:

1. A method for generating a panorama, comprising:
obtaining status information of a camera device during a video capture;
determining whether the status information meets a preset condition;
if the status information is determined to meet the preset condition, obtaining, from a video file generated from the video capture, a video clip corresponding to the status information; and
generating a panorama based on the video clip,

2. The method according to claim 1, wherein:
the status information comprises a speed of a horizontal movement of the camera device and an angle of the horizontal movement of the camera device; and
obtaining the status information of the camera device comprises:
obtaining, by a gyroscope, the speed of the horizontal movement of the camera device, and
obtaining, by the gyroscope, the angle of the horizontal movement of the camera device.

3. The method according to claim 2, wherein determining whether the status information meets the preset condition comprises:
determining whether the speed of the horizontal movement is smaller than a first preset threshold;
determining whether the angle of the horizontal movement is larger than a second preset threshold; and
if the speed of the horizontal movement is determined to be smaller than the first preset threshold and the angle of the horizontal movement is determined to be larger than the second preset threshold, determining that the status information meets the preset condition.

4. The method according to claim 3, further comprising:
if the speed of the horizontal movement is determined to be larger than the first preset threshold, and/or the angle of the horizontal movement is determined to be smaller than the second preset threshold, notifying a user that no video clip for generating the panorama can be obtained from the video file.

5. The method according to claim 1, wherein obtaining the video dip corresponding to the status information comprises:
obtaining a starting time of a horizontal movement of the camera device and an ending time of the horizontal movement of the camera device; and
obtaining the video clip according to the obtained starting time and the ending time.

6. The method according to claim 1, wherein:
the status information comprises a speed of a horizontal movement of the camera device and an angle of the horizontal movement of the camera device; and
obtaining the status information of the camera device comprises obtaining, fro a configuration file corresponding to the video file, the speed of the horizontal movement and the angle of the horizontal movement.

7. A device for generating a panorama, comprising:
a processor; and
a memory configured to store an instruction executable by the processor,
wherein the processor is configured to:
obtain status information of a camera device during a video capture;
determine whether the status information meets a preset condition;
if the status information is determined to meet the preset condition, obtain, from a video file generated from the video capture, a video clip corresponding to the status information; and
generate a panorama based on the video clip.

8. The device according to claim 7, wherein:
the status information comprises a speed of a horizontal movement of the camera device and an angle of the horizontal movement of the camera device;
the device further comprises a gyroscope; and
the processor is further configured to:
obtain the speed of the horizontal movement of the camera device using the gyroscope; and
obtain the angle of the horizontal movement of the camera device using the gyroscope.

9. The device according to claim 8, wherein the processor is further configured determine whether the speed of the horizontal movement is smaller than a first preset threshold;
determine whether the angle of the horizontal movement is larger than a second preset threshold; and
if the speed of the horizontal movement is determined to be smaller than the first preset threshold and the angle of the horizontal movement is determined to he larger than the second preset threshold, determine that the status information meets the preset condition.

10. The device according to claim 9, wherein the processor is further configured to:
if the speed of the horizontal movement is determined to be larger than the first preset threshold, and/or the angle of the horizontal movement is determined to be smaller than the second preset threshold, notify a user that no video clip for generating the panorama can be obtained from the video file.

11. The device according to claim 7, wherein the processor is further configured to:
determine a starting time of a horizontal movement of the camera device and an ending time of the horizontal movement of the camera device; and
determine the video clip according to the starting time and the ending time.

12. The device according to claim 7, wherein:
the status information comprises a speed of a horizontal movement of the camera device and an angle of the horizontal movement of the camera device; and
the processor is further configured to obtain, from a configuration file corresponding to the video file, the speed of the horizontal movement and the angle of the horizontal movement.

13. A non-transitory computer-readable storage medium storing instructions that, when executed by a processor, cause the processor to perform a method for generating a panorama, the method comprising:
obtaining status information of a camera device during a video capture;
determining whether the status information meets a preset condition;
if the status information is determined to meet the preset condition, obtaining, from a video file generated from the video capture, a video clip corresponding to the status information; and
generating a panorama based on the video dip.

14. The storage medium according to claim 13, wherein:
the status information comprises a speed of a horizontal movement of the camera device and an angle of the horizontal movement of the camera device; and
obtaining the status information of the camera device comprises:
obtaining, by a gyroscope, the speed of the horizontal movement of the camera device, and
obtaining, by the gyroscope, the angle of the horizontal movement of the camera device.

15. The storage medium according to claim 14, wherein determining whether the status information meets the preset condition comprises:
determining whether the speed of the horizontal movement is smaller than a first preset threshold;
determining whether the angle of the horizontal movement is larger than a second preset threshold; and
if the speed of the horizontal movement is determined to be smaller than the first preset threshold and the angle of the horizontal movement is determined to be larger than the second preset threshold, determining that the status information meets the preset condition.

16. The storage medium according to claim 15, wherein the method further comprises:
if the speed of the horizontal movement is determined to be larger than the first preset threshold, and/or the angle of the horizontal movement is determined to be smaller than the second preset threshold, notifying a user that no video clip for generating the panorama can be obtained from the video file.

17. The storage medium according to claim 13, wherein obtaining the video clip corresponding to the status information comprises:
obtaining a starting time of a horizontal movement of the camera device and an ending time of the horizontal movement of the camera device; and
obtaining the video clip according to the obtained starting time and the ending time.

18. The storage medium according to claim 13, wherein the status information comprises a speed of a horizontal movement of the camera device and an angle of the horizontal movement of the camera device; and
obtaining the status information of the camera device comprises obtaining, from a configuration file corresponding to the video file, the speed of the horizontal movement and the angle of the horizontal movement.
